(19) United States
(12) Patent Application Publication
(10) Pub. No.: US 2025/0234312 A1
(43) Pub. Date: Jul. 17, 2025

(54) REDUCING INTER-FREQUENCY MEASUREMENTS IN HETEROGENOUS CELLULAR NETWORKS

(71) Applicant: CommScope Technologies LLC, Claremont, NC (US)

(72) Inventors: Shiva Prakash, Bangalore (IN); Minyan Shi, Bolton, MA (US)

(73) Assignee: CommScope Technologies LLC, Claremont, NC (US)

(21) Appl. No.: 19/012,198

(22) Filed: Jan. 7, 2025

Related U.S. Application Data
(60) Provisional application No. 63/621,963, filed on Jan. 17, 2024.

(51) Int. Cl. H04W 56/00; H04B 17/309; H04B 17/318; H04W 24/10

(52) U.S. Cl. CPC H04W 56/0015; H04B 17/328; H04B 17/346; H04W 24/10

(57) ABSTRACT

A serving cell unit includes circuitry communicatively coupled to core network(s), wherein the circuitry is configured to: exchange radio frequency signals with user equipment; initialize the circuitry with an initial SSB-ARFCN for a given operating channel of the serving cell unit; precompute all sync rasters which can be used as potential SSB-ARFCNs for the given operating channel of the serving cell unit; perform neighbor cell measurements of at least one neighbor cell by configuring the circuitry to: (1) perform measurements on the potential SSB-ARFCNs; and (2) obtain PCIs and associated SS-RSRP and SS-SINR for the potential SSB-ARFCNs; and re-configure the circuitry to an appropriate SSB-ARFCN of the potential SSB-ARFCNs based on: (1) a maximum number of PCIs for the potential SSB-ARFCNs; (2) the SS-RSRP exceeding an SS-RSRP threshold; and (3) a combination of the SS-RSRP exceeding the SS-RSRP threshold and not selecting potential SSB-ARFCNs of PCIs below a SS-SINR threshold.

### CROSS-REFERENCE TO RELATED APPLICATIONS

This application claims the benefit of U.S. Provisional Patent Application Ser. No. 63/621,963, filed on Jan. 17, 2024 and entitled “REDUCING INTER-FREQUENCY MEASUREMENTS IN HETEROGENOUS CELLULAR NETWORKS”, which is hereby incorporated herein by reference in its entirety.

### BACKGROUND

Cellular networks may be implemented using macro cells and/or small cells.

### SUMMARY

A serving cell unit includes: circuitry communicatively coupled to at least one core network; wherein the circuitry is configured to: exchange radio frequency signals with user equipment; initialize the circuitry with an initial Synchronization Signal Block Absolute Radio-Frequency Channel Number (SSB-ARFCN) for a given operating channel of the serving cell unit; precompute all sync rasters which can be used as potential SSB-ARFCNs for the given operating channel of the serving cell unit; perform neighbor cell measurements of at least one neighbor cell by configuring the circuitry to: (1) perform measurements on the potential SSB-ARFCNs; and (2) obtain physical cell IDs (PCIs) and associated synchronization signal reference signal received power (SS-RSRP) and synchronization signal signal to interference & noise ratio (SS-SINR) for the potential SSB-ARFCNs; and re-configure the circuitry to an appropriate SSB-ARFCN of the potential SSB-ARFCNs based on: (1) a maximum number of PCIs for the potential SSB-ARFCNs; (2) the SS-RSRP exceeding an SS-RSRP threshold; and (3) a combination of the SS-RSRP exceeding the SS-RSRP threshold and not selecting the potential SSB-ARFCNs of PCIs below a SS-SINR threshold.

A method includes: initializing serving cell circuitry implementing a serving cell with an initial Synchronization Signal Block Absolute Radio-Frequency Channel Number (SSB-ARFCN) for a given operating channel of the serving cell, wherein the serving cell circuitry is communicatively coupled to at least one core network; precompute all sync rasters which can be used as potential SSB-ARFCNs for the given operating channel of the serving cell circuitry; performing neighbor cell measurements of at least one neighbor cell by configuring the serving cell circuitry to: (1) perform measurements on the potential SSB-ARFCNs; and (2) obtain physical cell IDs (PCIs) and associated synchronization signal reference signal received power (SS-RSRP) and synchronization signal signal to interference & noise ratio (SS-SINR) for the potential SSB-ARFCNs; and re-configuring the serving cell circuitry to an appropriate SSB-ARFCN of the potential SSB-ARFCNs based on: (1) a maximum number of PCIs for the potential SSB-ARFCNs; (2) the SS-RSRP exceeding an SS-RSRP threshold; and (3) a combination of the SS-RSRP exceeding the SS-RSRP threshold and not selecting the potential SSB-ARFCNs of PCIs below a SS-SINR threshold.

A communication system includes: serving cell circuitry implementing a serving cell, the serving cell circuitry communicatively coupled to at least one core network, wherein the serving cell circuitry is configured to exchange radio frequency signals with user equipment within the serving cell; neighbor cell circuitry implementing a neighbor cell, the neighbor cell circuitry communicatively coupled to the at least one core network, wherein the neighbor cell circuitry is configured to exchange radio frequency signals with the user equipment within the neighbor cell; and wherein the serving cell circuitry is configured to: initialize the serving cell circuitry with an initial Synchronization Signal Block Absolute Radio-Frequency Channel Number (SSB-ARFCN) for a given operating channel of the serving cell; precompute all sync rasters which can be used as potential SSB-ARFCNs for the given operating channel of the serving cell; perform neighbor cell measurements of the neighbor cell by configuring the serving cell circuitry to: (1) perform measurements on the potential SSB-ARFCNs; and (2) obtain physical cell IDs (PCIs) and associated synchronization signal reference signal received power (SS-RSRP) and synchronization signal signal to interference & noise ratio (SS-SINR) for the potential SSB-ARFCNs; and re-configure the serving cell circuitry to an appropriate SSB-ARFCN of the potential SSB-ARFCNs based on: (1) a maximum number of PCIs for the potential SSB-ARFCNs; (2) the SS-RSRP exceeding an SS-RSRP threshold; and (3) a combination of the SS-RSRP exceeding the SS-RSRP threshold and not selecting the potential SSB-ARFCNs of PCIs below a SS-SINR threshold.

### BRIEF DESCRIPTION OF DRAWINGS

Understanding that the drawings depict only exemplary configurations and are not therefore to be considered limiting in scope, the exemplary configurations will be described with additional specificity and detail through the use of the accompanying drawings, in which:

FIG. 1 is a block diagram illustrating an example of a communication system implemented using heterogenous cellular network having both small cells/remote unit(s) and macro cell base station(s).

FIGS. 2A-2C show three example diagrams of channels showing ways in which bandwidth for a serving cell having a number of channels and bandwidth for a neighboring cell having a number of channels may overlap in different ways.

FIGS. 3A-3B are flow diagrams illustrating example methods for selecting an SSB-ARFCN based on user equipment (UE) measurements and/or a Radio Environment Measurement monitor (REM).

In accordance with common practice, the various described features are not drawn to scale but are drawn to emphasize specific features relevant to the exemplary configurations.

### DETAILED DESCRIPTION

In example fifth generation (5G) New Radio (NR) radio access networks (RAN), a Synchronization Signal Block (SSB) based measurement is considered as intra-frequency measurement if (1) the center frequency of the SSB of the serving cell indicated for measurement and the center frequency of the SSB of the neighbor cell are the same; and (2) the subcarrier spacing of the two SSBs are also the same. In an example 5G stand-alone (SA) deployment, the SSB center frequency, identified by Synchronization Signal Block Absolute Radio-Frequency Channel Number (SSB)-ARFCN (NR Absolute Radio Frequency Channel Number), has to align with one of the synchronization raster frequencies, identified by GSCN (Global Synchronization Channel Number) within a given NR channel. Table 5.4.3.1-1 in the 3rd Generation Partnership Project (3GPP) 38.104 specification defines the synchronization raster positions for the NR bands in FR1, FR2 frequency range, where sync raster is separated by 1.2 MHz, 1.44 MHz, 17.28 MHz for bands in the sub-3 GHZ, 3 to 24.25 GHz, and 24.25 to 100 GHz respectfully as follows:

TABLE 54.3.1-1
GSCN parameters for the global frequency raster

| Range of | | | |
|---|---|---|---|
| frequencies | SS block frequency position | | Range of |
| (MHz) | SS_{REF} | GSCN | GSCN |
| 0-3000 | N * 1200 kHz + M * 50 kHz, | 3N + | 2-7498 |
| | N = 1:2499, M ϵ {1, 3, 5} | (M − 3)/2 | |
| | (Note) | | |
| 3000-24250 | 3000 MHz + N * 1.44 MHz, | 7499 + N | 7499-22255 |
| | N = 0:14756 | | |
| 24250-100000 | 24250.08 MHz + N * 17.28 | 22256 + N | 22256-26639 |
| | MHz, N = 0:4383 | | |

NOTE:
The default value for operating bands which only support SCS spaced channel raster(s) is M = 3.

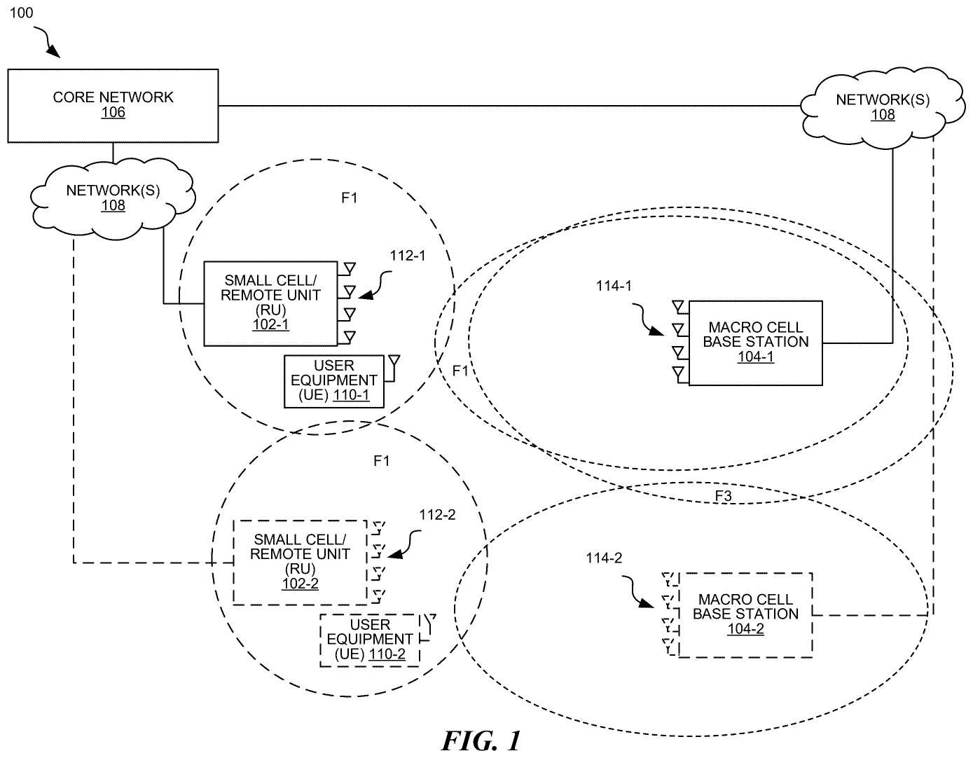

FIG. 1 is a block diagram illustrating an example of a communication system 100 implemented using a heterogenous cellular network having both small cell(s)/remote unit(s) (RU) 102 (such as small cell/RU 102-1 and any quantity of optional small cell/RU 102 through optional small cell/RU 102-2) and macro cell base station(s) 104 (such as macro cell base station 104-1 and any quantity of optional macro cell base station 104 through optional macro cell base station 104-2). In examples, each small cell/RU 102 is communicatively coupled to core network(s) 106 through network(s) 108. In examples, each small cell/RU 102 is communicatively coupled to core network(s) 106 through network(s) 108. In examples, each of the network(s) 108 may include backhaul network(s), midhaul network(s), and/or fronthaul network(s) that may be implemented with one or more switches, routers, and/or other networking devices (such as switched Ethernet using a switched Ethernet network and an Ethernet switch).

In examples, each small cell/RU 102 is configured to communicate with user equipment (UE) 110 (such as user equipment (UE) 110-1 and any quantity of optional UE 110 through optional UE 110-2) via antenna(s) 112 (such as antenna(s) 112-1 and any quantity of optional antenna 112 through optional antenna 112-2). In examples, each macro cell base station 104 is configured to communication with user equipment (UE) 110 (such as user equipment (UE) 110-1 and any quantity of optional UE 110 through optional UE 110-2) via antenna(s) 114 (such as antenna(s) 114-1 and any quantity of optional antenna(s) 114 through optional antenna(s) 114-2). In examples of a heterogenous deployment, small cell/RU 102-1 and small cell/RU 102-2 may operate with GSCN SSB-ARFCN F1, while the macro cell base station 104-1 and the macro cell base station 104-2 operate at F2 and F3 GSCN SSB-ARFCNs. In examples, it is beneficial for the small cell/RU 102-1 to operate either at F2 or F3 and for the small cell/RU 102-2 to operate at F2 based on the proximity to the strongest macro cells. In examples, the switch from the GSCN SSB-AFRCN can be automatic and based on the UE or REM measurements.

In examples, each small cell/RU 102 and/or macro cell base station 104 implement a “base station”, “base station entity”, or “base station system” (which in the context of a fifth generation (5G) New Radio (NR) system, may also be referred to as a “gNodeB” or “gNB”; in the context of a fourth generation (4G) Long Term Evolution (LTE) system, may also be referred to as an “evolved NodeB”, “eNodeB”, or “eNB”; and may take different names in other current or future generations of radio access networks (RAN) and communication networks). In examples, the RUs 102 may be physically separated from each other at the site at which wireless service is being provided. A base station may be used to provide UE(s) 110 with mobile access to the wireless network operator's core network 106 to enable UE(s) 110 to wirelessly communicate data and voice (using, for example, Voice over LTE (VOLTE) technology or a 3GPP 5G RAN providing wireless service using a 5G air interface).

In general, the communication system 100 is configured to provide wireless service to the UE(s) 110. Unless explicitly stated to the contrary, references to Layer 1, Layer 2, Layer 3, and other or equivalent layers (such as the Physical Layer or the Media Access Control (MAC) Layer) refer to layers of the particular wireless interface (for example, Fourth Generation (4G) Long Term Evolution (LTE) or Fifth Generation (5G) New Radio (NR)) used for wirelessly communicating with UE(s) 110. Furthermore, it is also to be understood that 5G NR embodiments can be used in both standalone and non-standalone modes (or other modes developed in the future) and the following description is not intended to be limited to any particular mode. Moreover, although some embodiments are described here as being implemented for use with 5G NR, other embodiments can be implemented for use with other wireless interfaces and the following description is not intended to be limited to any particular wireless interface.

In examples implementing 5G embodiments, each logical base station entity may be partitioned into a CU, DUs, and RUs and, for at least some of the physical channels, some physical-layer processing is performed in the DUs with the remaining physical-layer processing being performed in the RUs. In examples, it is understood that the techniques described here can be used with other wireless interfaces (for example, 4G LTE, or future implementations) and with other ways of implementing a base station entity (for example, using a conventional baseband band unit (BBU)/remote radio head (RRH) architecture). The various elements of the communication system can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in a field programmable gate array (FPGA), application specific integrated circuit (ASIC), etc.).

Elements of the system can be implemented as a physical network function (PNF) (for example, using dedicated physical programmable devices and other circuitry) and/or a virtual network function (VNF) (for example, using one or more general purpose servers (possibly with hardware acceleration) in a scalable cloud environment and in different locations within an operator's network (for example, in the operator's “edge cloud” or “central cloud”). Each VNF can be implemented using hardware virtualization, operating system virtualization (also referred to as containerization), and application virtualization as well as various combinations of two or more the preceding. Where containerization is used to implement a VNF, it may also be referred to as a “containerized network function” (CNF).

The actual physical links between devices may be implemented using different media, such as conductive media (copper, multi-rate, multi-mode cables, etc.) and optical media (fiber optic cables). In examples, each small cell/RU 102 includes one or more Ethernet network interfaces to couple each small cell/RU 102 to the network(s) in order to facilitate communications between the core network 106 and the small cell/RU 102. In examples, the small cell/RU 102 may be deployed at a site to provide wireless coverage and capacity for one or more wireless network operators. The site at which wireless service is being provided may cover, for example, a building or campus or other grouping of buildings (used, for example, by one or more businesses, governments, other enterprise entities) or some other public venue (such as a hotel, resort, amusement park, hospital, shopping center, university campus, arena, or an outdoor area such as a ski area, stadium or a densely populated downtown area). In some configurations, the site at which wireless service is being provided is at least partially (and optionally entirely) indoors, but other alternatives are possible.

Each UE 110 may be a computing device with at least one processor that executes instructions stored in memory, e.g., a mobile phone, tablet computer, mobile media device, mobile gaming device, laptop computer, vehicle-based computer, a desktop computer, etc.

In an example heterogenous 5G deployment including both small cell/RU(s) 102 and macro cell base station(s) 104, where the cells may belong to different vendors, the SSB-ARFCN of the neighboring cells might not be always aligned, even for neighboring cells operating on a same NR band (such as the same bandwidth (BW) or same channel center frequency). In examples of 5G deployments, an operator provides the information of the NR band operating frequency and bandwidth, the subcarrier spacing (such as the numerology) for Frequency Division Duplexed (FDD) or Time Division Duplexed (TDD), and the TDD-uplink-downlink-pattern (TDD-UL-DL-pattern) and special slot format for TDD implementations. In examples, the operator need not dictate the SSB NR-ARFCN to use and additionally it might not be viable to obtain the SSB-ARFCNs of the neighbors easily. In examples, each gNB vendor selects the SSB NR-ARFCN according to its own proprietary implementation.

In examples, intra-frequency is when two serving cells have the same SSB center frequency. If there is a difference between the SSB center frequency of the serving and the neighbor cell, then they call this measurement an inter-frequency measurement. In example 5G deployments, if SSB-ARFCNs of the Global Synchronization Channel Number (GSCN) are not aligned among the neighbor cells, then this requires measurement gaps to be supplied to the UE in most scenarios in order to identify new cells for the purposes of Automatic Neighbor Relation (ANR) and handover (HO). In examples, enabling measurement gaps impacts throughput performance and some signaling overhead. In examples, measurement gaps are needed to be provide to the UE 110 for inter-frequency measurement in the following cases: (A) when the UE 110 cannot perform inter-frequency SSB based measurements without measurement gaps even when the SSB is completely contained in the active bandwidth part (BWP) of the UE 110 (when the UE 110 does not support interFrequencyMeas-NoGap-r16); (B) when the UE 110 can perform the inter-frequency SSB measurements without measurement gaps (when the UE 110 does support interFrequencyMeas-NoGap-r16), but the source and inter-frequency cell are not time synchronized: (1) System Frame Number (SFN) and frame boundary across serving cell and inter-frequency neighbor cells is NOT aligned and/or (2) the timing of SSBs across serving cell and inter-frequency neighbor cells are NOT aligned.

In examples, the measurement gap impacts is minimized when the SSB-ARFCN is selected for a cell such that it has maximum intra-frequency neighbors based on certain criteria. In examples below, we discuss two methods to align the source cell SSB-ARFCN of a given NR channel, one based on UE 110 measurements and the other using REM enabled on the RU unit(s) 102. In examples, the channel may be defined by: (1) lower and higher frequency values; (2) lower frequency in combination with bandwidth; (3) higher frequency in combination with bandwidth; or (4) center frequency in combination with bandwidth.

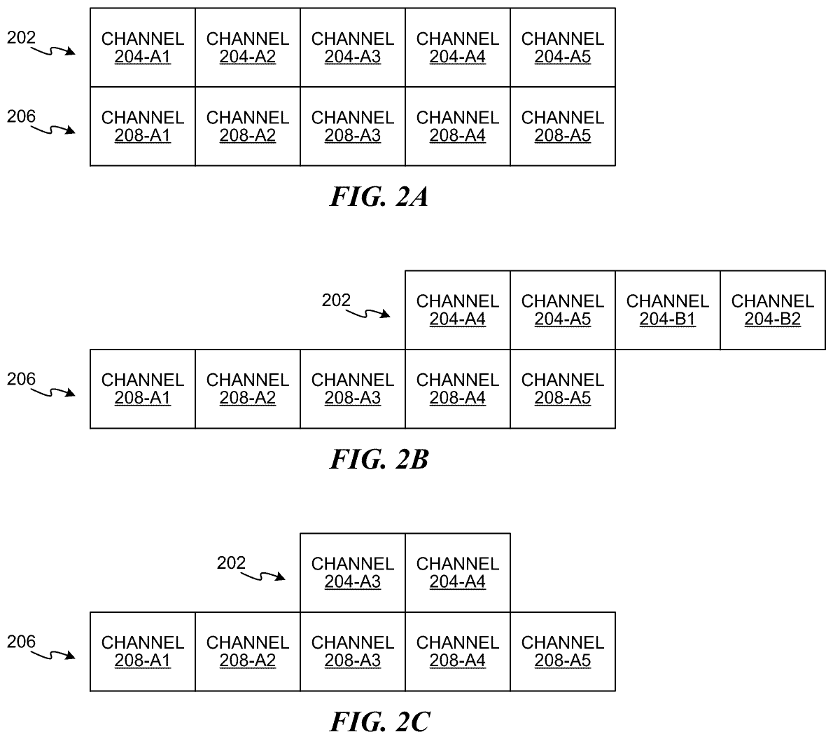

FIGS. 2A-2C show three example diagrams of channels showing ways in which bandwidth 202 for a serving cell (such as a small cell/remote unit (RU) 102) having a number of channels 204 and bandwidth 206 for a neighboring cell (such as a macro cell base station 104) having a number of channels 208 may overlap in different ways, including where serving and neighbor cells are operating on exactly the same NR channel or on different NR channels that partially or fully overlap in frequency. In examples, bandwidth 202 of the serving cell (such as a small cell/remote unit (RU) 102) is 100 MHz composed of channels 204 of 20 MHz license blocks of n77-C band. In examples, bandwidth 206 of the neighboring cell (such as a macro cell base station 104) is 100 MHz composed of channels 208 of 20 MHz license blocks of n77-C band. In other examples, the bandwidth 202 and the bandwidth 206 may be different sizes and be composed of different quantities of channels 204 and 208 of different sizes.

FIG. 2A shows an example where the bandwidth 202 for the serving cell (such as a small cell/remote unit (RU) 102) and the bandwidth 206 of the neighboring cell (such as a macro cell base station 104) share the same bandwidth and fully overlapping channels. Specifically, FIG. 2A shows an example where: (1) channel 204-A1 overlaps with channel 208-A1; (2) channel 204-A2 overlaps with channel 208-A2; (3) channel 204-A3 overlaps with channel 208-A3; (4) channel 204-A4 overlaps with channel 208-A4; and (5) channel 204-A5 overlaps with channel 208-A5.

FIG. 2B shows an example where the bandwidth 202 of the serving cell (such as a small cell/remote unit (RU) 102) and the bandwidth 206 of the neighboring cell (such as a macro cell base station 104) share some bandwidth with partially overlapping channels. Specifically, FIG. 2B shows an example where: (A) (1) channel 204-A4 overlaps with channel 208-A4; and (2) channel 204-A5 overlaps with channel 208-A5; (B) channel 208-A1, channel 208-A2, and channel 208-A3 do not overlap with any channel 204; and (C) channel 204-B1 and channel 204-B2 do not overlap with any channel 208.

FIG. 2C shows an example where bandwidth 202 of the serving cell (such as a small cell/remote unit (RU) 102) and the bandwidth 206 of the neighboring cell (such as a macro cell base station 104) share some fully overlapping channels. Specifically, FIG. 2C shows an example where: (A) (1) channel 204-A3 overlaps with channel 208-A3; and (2) channel 204-A4 overlaps with channel 208-A4; and (B) channel 208-A1, channel 208-A2, and channel 208-A5 do not overlap with any channels 204.

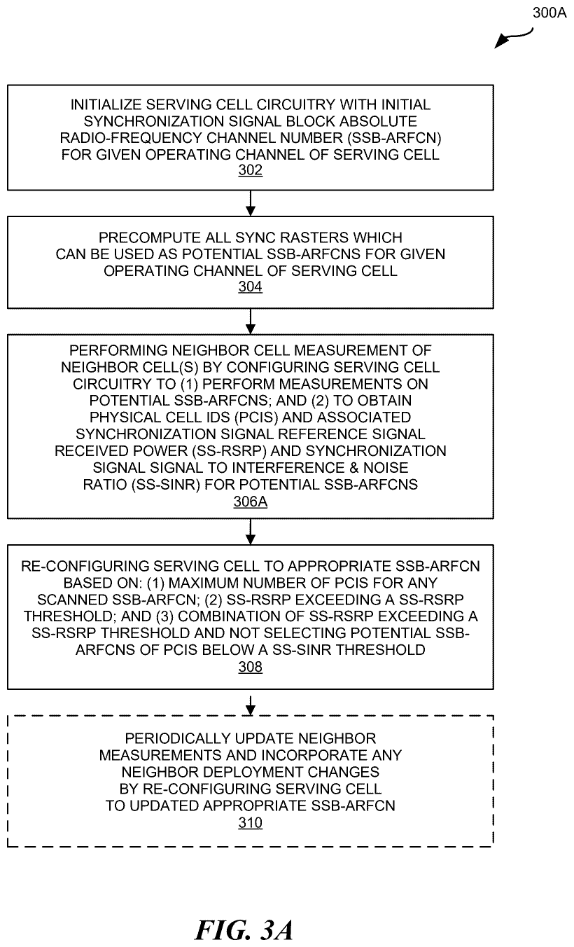

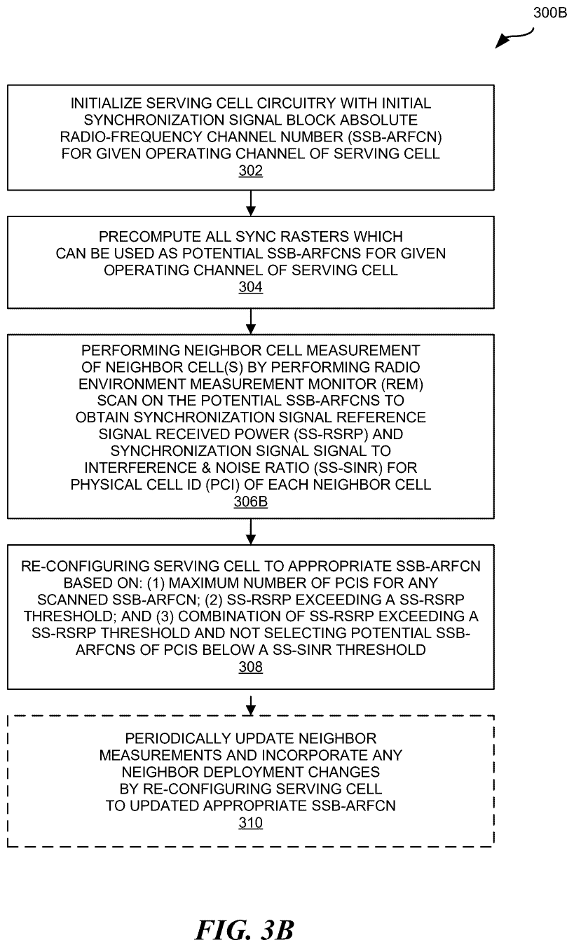

FIGS. 3A-3B are flow diagrams illustrating example methods 300 for selecting an SSB-ARFCN based on user equipment (UE) measurements and/or a Radio Environment Measurement monitor (REM). FIG. 3A is a flow diagram of a method 300A for selecting an SSB-ARFCN based on UE measurements. In exemplary embodiments, the method is performed within small cell hardware (such as a small cell/remote unit (RU) 102).

Exemplary method 300A begins with block 302 with initializing serving cell circuitry (such as a small cell/remote unit (RU) 102) with an initial SSB-ARFCN for a given operating channel of the serving cell. In examples, the given operating channel is provided through (Device Management System (DMS) configuration or computed automatically via an algorithm for a given downlink (DL) channel center frequency, channel bandwidth (BW), and subcarrier spacing. In examples, block 302 is performed without knowledge of the SSB-ARFCN positions of the neighbor cell(s) (such as other small cell/remote unit (RU) s 102 or macro base station(s) 104).

Exemplary method 300A proceeds to block 304 with precomputing all the sync rasters which can be used as potential SSB-ARFCNs (corresponding to SSREF in Table 5.4.3.1-1 in the 3GPP 38.104 specification) for the given operating channel of the serving cell. In examples, this results in the list of SSB-ARFCNs to be scanned to detect neighbors. In examples where knowledge about the neighbor channels is known, then the set of SSB-ARFCNs to be scanned will be the intersect of the frequencies in the overlapping channel area. In examples where knowledge about the neighbor channels is not known, all the SSB-ARFCNs in the serving cell's channel need to be considered for the scan.

Exemplary method 300A proceeds to block 306A with performing neighbor cell measurement of neighbor cell(s) by configuring the serving cell circuitry (such as a small cell/remote unit (RU) 102) to (1) perform measurements on the potential SSB-ARFCNs (using measurement gaps if necessary); and (2) to obtain the Physical Cell Ids (PCIs) and associated Synchronization Signal Reference Signal Received Power (SS-RSRP) and Synchronization Signal Signal to Interference & Noise Ratio (SS-SINR) for potential SSB-ARFCNs. In examples, the serving cell hardware is configured to perform measurements on the potential SSB-ARFCNs by setting the variables “rsrp” and “sinr” to TRUE in MeasReportQuantity IE in ReportConfigNR IE-38.331). In examples, the serving cell hardware (such as a small cell/remote unit (RU) 102) is configured to read the Cell Global Identity (CGI) information on the System Information Block Type1 (SIB1) to obtain the set of Public Land Mobile Networks (PLMNs) supported on a certain PCI.

Exemplary method 300A proceeds to block 308 with re-configuring the serving cell to the appropriate SSB-ARFCN based on the following criteria: (1) the maximum number of PCIs for any scanned SSB-ARFCN (in examples, if the PLMNs per PCI per ARFCN are obtained, then the PCIs are filtered based on a configured set of valid PLMNs allowed for the operator); (2) the SS-RSRP exceeding a SS-RSRP threshold; (3) combination of the SS-RSRP exceeding a SS-RSRP threshold and not selecting the potential SSB-ARFCNs of PCIs below a SS-SINR threshold. In examples where no neighbors are detected in the scan, then the SSB-ARFCN is set to (or maintained at) the value which was originally computed in block 302.

Exemplary method 300A proceeds to optional block 310 with periodically updating neighbor measurements using the UE measurements and/or REM and incorporating any neighbor deployment changes by re-configuring service cell to appropriate SSB-ARFCN.

FIG. 3B is a flow diagram of a method 300B for selecting an SSB-ARFCN based on Radio Environment Measurement monitor (REM). In exemplary embodiments, the REM is included within small cell hardware (such as a small cell/remote unit (RU) 102). Block 306B of method 300B differs from block 306A of method 300A and block 306B is where method 300B generally differs from method 300A. Block 302, block 304, block 308, and block 310 are generally the same in method 300B as in method 300A.

Exemplary method 300B begins with block 302 and 304 as described above with reference to exemplary method 300A shown in FIG. 3A. Exemplary method 300B proceeds to block 306B with performing neighbor cell measurement of neighbor cell(s) by performing a Radio Environment Measurement monitor (REM) scan on the potential SSB-ARFCNs to obtain Synchronization Signal Reference Signal Received Power (SS-RSRP) and Synchronization Signal Signal to Interference & Noise Ratio (SS-SINR) for Physical Cell Id (PCI) of each neighbor cell. In examples, the REM optionally obtains the set of PLMNs supported on a certain PCI by decoding the SIB1 for each neighbor PCI on a given ARFCN. Exemplary method 300B then proceeds to blocks 308 and 310.

The methods disclosed herein comprise one or more steps or actions for achieving the described method. Unless a specific order of steps or actions is required for proper operation of the method that is being described, the order and/or use of specific steps and/or actions may be modified without departing from the scope of the claims.

While detailed descriptions of one or more configurations of the disclosure have been given above, various alternatives, modifications, and equivalents will be apparent to those skilled in the art without varying from the spirit of the disclosure. For example, while the configurations described above refer to particular features, functions, procedures, components, elements, and/or structures, the scope of this disclosure also includes configurations having different combinations of features, functions, procedures, components, elements, and/or structures, and configurations that do not include all of the described features, functions, procedures, components, elements, and/or structures. Accordingly, the scope of the present disclosure is intended to embrace all such alternatives, modifications, and variations as fall within the scope of the claims, together with all equivalents thereof. Therefore, the above description should not be taken as limiting.

### Examples

Example 1 includes a serving cell unit comprising: circuitry communicatively coupled to at least one core network; wherein the circuitry is configured to: exchange radio frequency signals with user equipment; initialize the circuitry with an initial Synchronization Signal Block Absolute Radio-Frequency Channel Number (SSB-ARFCN) for a given operating channel of the serving cell unit; precompute all sync rasters which can be used as potential SSB-ARFCNs for the given operating channel of the serving cell unit; perform neighbor cell measurements of at least one neighbor cell by configuring the circuitry to: (1) perform measurements on the potential SSB-ARFCNs; and (2) obtain physical cell IDs (PCIs) and associated synchronization signal reference signal received power (SS-RSRP) and synchronization signal signal to interference & noise ratio (SS-SINR) for the potential SSB-ARFCNs; and re-configure the circuitry to an appropriate SSB-ARFCN of the potential SSB-ARFCNs based on: (1) a maximum number of PCIs for the potential SSB-ARFCNs; (2) the SS-RSRP exceeding an SS-RSRP threshold; and (3) a combination of the SS-RSRP exceeding the SS-RSRP threshold and not selecting the potential SSB-ARFCNs of PCIs below a SS-SINR threshold.

Example 2 includes the serving cell unit of Example 1, wherein the circuitry is configured to: periodically update the neighbor cell measurements; and incorporate any neighbor deployment changes by being configured to re-configure the circuitry to an updated appropriate SSB-ARFCN.

Example 3 includes the serving cell unit of any of Examples 1-2, wherein: the serving cell unit includes a remote unit having the circuitry; and the at least one neighbor cell is implemented by a macro cell base station having neighbor cell circuitry.

Example 4 includes the serving cell unit of any of Examples 1-3, wherein being configured to re-configure the circuitry to the appropriate SSB-ARFCN of the potential SSB-ARFCNs minimizes measurement gap impacts.

Example 5 includes the serving cell unit of any of Examples 1-4, wherein the circuitry includes: a radio environment measurement monitor (REM) configured to monitor the at least one neighbor cell.

Example 6 includes the serving cell unit of Example 5, wherein the radio environment measurement monitor (REM) is configured to perform the neighbor cell measurements of the at least one neighbor cell by: performing radio environment measurement monitor (REM) scan on the potential SSB-ARFCNs to obtain the SS-RSRP and the SS-SINR for the PCIs of each neighbor cell.

Example 7 includes the serving cell unit of any of Examples 1-6, wherein the circuitry is configured to initialize the circuitry with the initial SSB-ARFCN for the given operating channel of the serving cell unit without information regarding the SSB-ARFCN of the at least one neighbor cell.

Example 8 includes a method comprising: initializing serving cell circuitry implementing a serving cell with an initial Synchronization Signal Block Absolute Radio-Frequency Channel Number (SSB-ARFCN) for a given operating channel of the serving cell, wherein the serving cell circuitry is communicatively coupled to at least one core network; precomputing all sync rasters which can be used as potential SSB-ARFCNs for the given operating channel of the serving cell circuitry; performing neighbor cell measurements of at least one neighbor cell by configuring the serving cell circuitry to: (1) perform measurements on the potential SSB-ARFCNs; and (2) obtain physical cell IDs (PCIs) and associated synchronization signal reference signal received power (SS-RSRP) and synchronization signal signal to interference & noise ratio (SS-SINR) for the potential SSB-ARFCNs; and re-configuring the serving cell circuitry to an appropriate SSB-ARFCN of the potential SSB-ARFCNs based on: (1) a maximum number of PCIs for the potential SSB-ARFCNs; (2) the SS-RSRP exceeding an SS-RSRP threshold; and (3) a combination of the SS-RSRP exceeding the SS-RSRP threshold and not selecting the potential SSB-ARFCNs of PCIs below a SS-SINR threshold.

Example 9 includes the method of Example 8, further comprising: periodically updating the neighbor cell measurements; and incorporating any neighbor deployment changes by re-configuring the serving cell circuitry to an updated appropriate SSB-ARFCN.

Example 10 includes the method of any of Examples 8-9, wherein: the serving cell circuitry is included in a remote unit; and the at least one neighbor cell is implemented by a macro cell base station.

Example 11 includes the method of any of Examples 8-10, wherein re-configuring the serving cell circuitry to the appropriate SSB-ARFCN of the potential SSB-ARFCNs minimizes measurement gap impacts.

Example 12 includes the method of any of Examples 8-11, wherein performing the neighbor cell measurements of the at least one neighbor cell includes: performing radio environment measurement monitor (REM) scan on the potential SSB-ARFCNs to obtain the SS-RSRP and the SS-SINR for the PCIs of each neighbor cell.

Example 13 includes the method of any of Examples 8-12, further comprising: initializing the serving cell circuitry implementing the serving cell with the initial SSB-ARFCN for the given operating channel of the serving cell without information regarding the SSB-ARFCN of the at least one neighbor cell.

Example 14 includes a communication system comprising: serving cell circuitry implementing a serving cell, the serving cell circuitry communicatively coupled to at least one core network, wherein the serving cell circuitry is configured to exchange radio frequency signals with user equipment within the serving cell; neighbor cell circuitry implementing a neighbor cell, the neighbor cell circuitry communicatively coupled to the at least one core network, wherein the neighbor cell circuitry is configured to exchange radio frequency signals with the user equipment within the neighbor cell; and wherein the serving cell circuitry is configured to: initialize the serving cell circuitry with an initial Synchronization Signal Block Absolute Radio-Frequency Channel Number (SSB-ARFCN) for a given operating channel of the serving cell; precompute all sync rasters which can be used as potential SSB-ARFCNs for the given operating channel of the serving cell; perform neighbor cell measurements of the neighbor cell by configuring the serving cell circuitry to: (1) perform measurements on the potential SSB-ARFCNs; and (2) obtain physical cell IDs (PCIs) and associated synchronization signal reference signal received power (SS-RSRP) and synchronization signal signal to interference & noise ratio (SS-SINR) for the potential SSB-ARFCNs; and re-configure the serving cell circuitry to an appropriate SSB-ARFCN of the potential SSB-ARFCNs based on: (1) a maximum number of PCIs for the potential SSB-ARFCNs; (2) the SS-RSRP exceeding an SS-RSRP threshold; and (3) a combination of the SS-RSRP exceeding the SS-RSRP threshold and not selecting the potential SSB-ARFCNs of PCIs below a SS-SINR threshold.

Example 15 includes the communication system of Example 14, wherein the serving cell circuitry is configured to: periodically update the neighbor cell measurements; and incorporate any neighbor deployment changes by being configured to re-configure the serving cell circuitry to an updated appropriate SSB-ARFCN.

Example 16 includes the communication system of any of Examples 14-15, further comprising: a remote unit including the serving cell circuitry; and a macro cell base station including the neighbor cell circuitry.

Example 17 includes the communication system of any of Examples 14-16, wherein being configured to re-configure the serving cell circuitry to the appropriate SSB-ARFCN of the potential SSB-ARFCNs minimizes measurement gap impacts.

Example 18 includes the communication system of any of Examples 14-17, wherein the serving cell circuitry is configured to perform the neighbor cell measurements of the neighbor cell by: performing radio environment measurement monitor (REM) scan on the potential SSB-ARFCNs to obtain the SS-RSRP and the SS-SINR for the PCIs of each neighbor cell.

Example 19 includes the communication system of any of Examples 14-18, wherein the serving cell circuitry includes: a radio environment measurement monitor (REM) configured to monitor the neighbor cell.

Example 20 includes the communication system of Example 19, wherein the radio environment measurement monitor (REM) is configured to perform the neighbor cell measurements of the neighbor cell by: performing radio environment measurement monitor (REM) scan on the potential SSB-ARFCNs to obtain the SS-RSRP and the SS-SINR for the PCIs of each neighbor cell.

What is claimed is:

1. A serving cell unit comprising:
circuitry communicatively coupled to at least one core network;
wherein the circuitry is configured to:
exchange radio frequency signals with user equipment;
initialize the circuitry with an initial Synchronization Signal Block Absolute Radio-Frequency Channel Number (SSB-ARFCN) for a given operating channel of the serving cell unit;
precompute all sync rasters which can be used as potential SSB-ARFCNs for the given operating channel of the serving cell unit;
perform neighbor cell measurements of at least one neighbor cell by configuring the circuitry to: (1) perform measurements on the potential SSB-ARFCNs; and (2) obtain physical cell IDs (PCIs) and associated synchronization signal reference signal received power (SS-RSRP) and synchronization signal signal to interference & noise ratio (SS-SINR) for the potential SSB-ARFCNs; and
re-configure the circuitry to an appropriate SSB-ARFCN of the potential SSB-ARFCNs based on: (1) a maximum number of PCIs for the potential SSB-ARFCNs; (2) the SS-RSRP exceeding an SS-RSRP threshold; and (3) a combination of the SS-RSRP exceeding the SS-RSRP threshold and not selecting the potential SSB-ARFCNs of PCIs below a SS-SINR threshold.

2. The serving cell unit of claim 1, wherein the circuitry is configured to:
periodically update the neighbor cell measurements; and
incorporate any neighbor deployment changes by being configured to re-configure the circuitry to an updated appropriate SSB-ARFCN.

3. The serving cell unit of claim 1, wherein:
the serving cell unit includes a remote unit having the circuitry; and
the at least one neighbor cell is implemented by a macro cell base station having neighbor cell circuitry.

4. The serving cell unit of claim 1, wherein being configured to re-configure the circuitry to the appropriate SSB-ARFCN of the potential SSB-ARFCNs minimizes measurement gap impacts.

5. The serving cell unit of claim 1, wherein the circuitry includes:
a radio environment measurement monitor (REM) configured to monitor the at least one neighbor cell.

6. The serving cell unit of claim 5, wherein the radio environment measurement monitor (REM) is configured to perform the neighbor cell measurements of the at least one neighbor cell by:
performing radio environment measurement monitor (REM) scan on the potential SSB-ARFCNs to obtain the SS-RSRP and the SS-SINR for the PCIs of each neighbor cell.

7. The serving cell unit of claim 1, wherein the circuitry is configured to initialize the circuitry with the initial SSB-ARFCN for the given operating channel of the serving cell unit without information regarding the SSB-ARFCN of the at least one neighbor cell.

8. A method comprising:
initializing serving cell circuitry implementing a serving cell with an initial Synchronization Signal Block Absolute Radio-Frequency Channel Number (SSB-ARFCN) for a given operating channel of the serving cell, wherein the serving cell circuitry is communicatively coupled to at least one core network;
precomputing all sync rasters which can be used as potential SSB-ARFCNs for the given operating channel of the serving cell circuitry;
performing neighbor cell measurements of at least one neighbor cell by configuring the serving cell circuitry to: (1) perform measurements on the potential SSB-ARFCNs; and (2) obtain physical cell IDs (PCIs) and associated synchronization signal reference signal received power (SS-RSRP) and synchronization signal signal to interference & noise ratio (SS-SINR) for the potential SSB-ARFCNs; and
re-configuring the serving cell circuitry to an appropriate SSB-ARFCN of the potential SSB-ARFCNs based on: (1) a maximum number of PCIs for the potential SSB-ARFCNs; (2) the SS-RSRP exceeding an SS-RSRP threshold; and (3) a combination of the SS-RSRP exceeding the SS-RSRP threshold and not selecting the potential SSB-ARFCNs of PCIs below a SS-SINR threshold.

9. The method of claim 8, further comprising:
periodically updating the neighbor cell measurements; and
incorporating any neighbor deployment changes by re-configuring the serving cell circuitry to an updated appropriate SSB-ARFCN.

10. The method of claim 8, wherein:
the serving cell circuitry is included in a remote unit; and
the at least one neighbor cell is implemented by a macro cell base station.

11. The method of claim 8, wherein re-configuring the serving cell circuitry to the appropriate SSB-ARFCN of the potential SSB-ARFCNs minimizes measurement gap impacts.

12. The method of claim 8, wherein performing the neighbor cell measurements of the at least one neighbor cell includes:
performing radio environment measurement monitor (REM) scan on the potential SSB-ARFCNs to obtain the SS-RSRP and the SS-SINR for the PCIs of each neighbor cell.

13. The method of claim 8, further comprising:
initializing the serving cell circuitry implementing the serving cell with the initial SSB-ARFCN for the given operating channel of the serving cell without information regarding the SSB-ARFCN of the at least one neighbor cell.

14. A communication system comprising:
serving cell circuitry implementing a serving cell, the serving cell circuitry communicatively coupled to at least one core network, wherein the serving cell circuitry is configured to exchange radio frequency signals with user equipment within the serving cell;
neighbor cell circuitry implementing a neighbor cell, the neighbor cell circuitry communicatively coupled to the at least one core network, wherein the neighbor cell circuitry is configured to exchange radio frequency signals with the user equipment within the neighbor cell; and
wherein the serving cell circuitry is configured to:
initialize the serving cell circuitry with an initial Synchronization Signal Block Absolute Radio-Frequency Channel Number (SSB-ARFCN) for a given operating channel of the serving cell;
precompute all sync rasters which can be used as potential SSB-ARFCNs for the given operating channel of the serving cell;
perform neighbor cell measurements of the neighbor cell by configuring the serving cell circuitry to: (1) perform measurements on the potential SSB-ARFCNs; and (2) obtain physical cell IDs (PCIs) and associated synchronization signal reference signal received power (SS-RSRP) and synchronization signal signal to interference & noise ratio (SS-SINR) for the potential SSB-ARFCNs; and
re-configure the serving cell circuitry to an appropriate SSB-ARFCN of the potential SSB-ARFCNs based on: (1) a maximum number of PCIs for the potential SSB-ARFCNs; (2) the SS-RSRP exceeding an SS-RSRP threshold; and (3) a combination of the SS-RSRP exceeding the SS-RSRP threshold and not selecting the potential SSB-ARFCNs of PCIs below a SS-SINR threshold.

15. The communication system of claim 14, wherein the serving cell circuitry is configured to:
periodically update the neighbor cell measurements; and
incorporate any neighbor deployment changes by being configured to re-configure the serving cell circuitry to an updated appropriate SSB-ARFCN.

16. The communication system of claim 14, further comprising:
a remote unit including the serving cell circuitry; and
a macro cell base station including the neighbor cell circuitry.

17. The communication system of claim 14, wherein being configured to re-configure the serving cell circuitry to the appropriate SSB-ARFCN of the potential SSB-ARFCNs minimizes measurement gap impacts.

18. The communication system of claim 14, wherein the serving cell circuitry is configured to perform the neighbor cell measurements of the neighbor cell by:
performing radio environment measurement monitor (REM) scan on the potential SSB-ARFCNs to obtain the SS-RSRP and the SS-SINR for the PCIs of each neighbor cell.

19. The communication system of claim 14, wherein the serving cell circuitry includes:
a radio environment measurement monitor (REM) configured to monitor the neighbor cell.

20. The communication system of claim 19, wherein the radio environment measurement monitor (REM) is configured to perform the neighbor cell measurements of the neighbor cell by:
performing radio environment measurement monitor (REM) scan on the potential SSB-ARFCNs to obtain the SS-RSRP and the SS-SINR for the PCIs of each neighbor cell.
